(19) United States
(12) Patent Application Publication
(10) Pub. No.: US 2015/0226127 A1
(43) Pub. Date: Aug. 13, 2015

(54) BRAZELESS END COVER FOR A COMBUSTION SYSTEM

(71) Applicants: KEVIN BRADY POWELL, Jupiter, FL (US); David John Henriquez, Hobe Sound, FL (US); Paul Economo, Jupiter, FL (US)

(72) Inventors: KEVIN BRADY POWELL, Jupiter, FL (US); David John Henriquez, Hobe Sound, FL (US); Paul Economo, Jupiter, FL (US)

(73) Assignees: Kevin Brady Powel, Jupiter, FL (US); David John Henriquez, Hobe Sound, FL (US); Paul Economo, Jupiter, FL (US)

(21) Appl. No.: 14/621,908

(22) Filed: Feb. 13, 2015

Related U.S. Application Data
(60) Provisional application No. 61/939,456, filed on Feb. 13, 2014.

(51) Int. Cl. F02C 7/22; F02C 7/16; F23R 3/10; F23R 3/28

(52) U.S. Cl. CPC F02C 7/222; F23R 3/28; F02C 7/16; F23R 3/10; F23R 2900/00018; F05D 2220/32; F05D 2230/60

(57) ABSTRACT

Aspects of the present invention relate to systems and method for fabricating a combustor end cover where the cover does not include braze joints within the cover. The combustor cover provides a configuration and method of manufacturing where all fuel and air annuli can be placed within the cover without requiring use of brazed inserts, which were previously known to crack and leak.

### CROSS-REFERENCE TO RELATED APPLICATIONS

This application claims priority to U.S. Provisional Patent Application Ser. No. 61/939,456 filed on Feb. 13, 2014.

### TECHNICAL FIELD

The present invention generally relates to a fuel system for a gas turbine combustor, and more specifically to an end cover that supplies fuel and air to the fuel nozzles of the combustor.

### BACKGROUND OF THE INVENTION

In a typical gas turbine engine, a compressor having alternating stages of rotating and stationary airfoils is coupled to a turbine, which also has alternating stages of rotating and stationary airfoils. The compressor stages decrease in size, and as the volume of each stage of the compressor decreases, the air passing therethrough is compressed, raising its temperature and pressure. The compressed air is then supplied to one or more combustors which mixes the air with fuel and ignites the mixture to form hot combustion gases. The hot combustion gases are directed into a turbine, where the expansion of the hot combustion gases drives the stages of a turbine, which, in turn drives the compressor, as the compressor is coupled to the turbine via a shaft. The exhaust gases exiting the turbine can then be used as a source of propulsion, as typical in an aircraft engine, or in powerplant operations to turn a shaft coupled to a generator for producing electricity.

The exact type and size of combustion systems used in a gas turbine engine can vary depending on a variety of factors such as engine geometry, performance requirements, and fuel type. For example, the combustion system of a gas turbine engine can comprise a plurality of individual combustors. Each combustor can typically include at least one fuel injection means and ignition source, and may in fact have multiple fuel injection sources.

The combustor can comprise one or more individual combustion systems. The combustor receives the air from the compressor, mixes fuel within the compressed air, and exposes this mixture to a flame source, causing the fuel-air mixture to ignite. Through the combustion process, the fuel-air mixture rapidly increases in temperature and provides the heated air to a turbine for driving the turbine.

One of the components of a gas turbine combustor is an end cover. The end cover, such as the prior art end cover 10 of FIG. 1, encloses a combustion system. Combustion systems an often employ a plurality of fuel nozzles, with the fuel nozzles often utilizing both fuel and air injection capabilities. The end cover is used to direct fuel(s) and air to the fuel nozzles from supply lines. In fact, many gas turbine combustors operate on multiple fuel types, such as a gaseous fuel and a liquid fuel. Therefore, for an end cover of a gas turbine combustor operating on both liquid and gaseous fuel, it is conceivable that the end cover will have a very complex design to keep fuels and air sources separate, yet both supplied to the plurality of fuel nozzles.

In order to keep the various fuel and air sources separate, end covers 10 of the prior art often involve a series of cavities and brazed inserts to form internal passageways within the end cover. Referring to FIG. 1, the end cover 10 comprises a series of fuel and air passageways within the cover. The passageways are at least in part formed by a brazed insert 12 which is configured in a way, such that when it is joined to the end cover 10, a series of distinct passageways are formed. A brazed insert 12 allows for more rudimentary machining of the cover 10. However, joints around the brazed inserts 12 have been known to crack or fail.

### SUMMARY

In accordance with the present invention, there is provided a novel and improved system and method for distributing fuel and air within a cover of a gas turbine combustor. More specifically, an embodiment of the present invention comprises a cover for a gas turbine combustor having a forward face and an opposing aft face spaced a distance apart thereby establishing a cover thickness. The cover also has a central passageway extending through the cover along a central axis for supplying a gaseous fuel to a first fuel nozzle positioned along the central axis. The cover also includes a plurality of fuel and air circuits positioned within the cover, where the fuel and air circuits are split between a first portion and second portion. Each of the fuel and air circuits in the first portion comprises a first core passage extending along a first circuit centerline, a cooling air supply annulus positioned radially outward of the first core passage, an atomizing air supply annulus positioned such that it intersects the core passage, and a first gas fuel supply annulus located adjacent the aft face of the cover. Each of the fuel and air circuits in the second portion comprises a second core passage extending along a second circuit centerline, a cooling air supply annulus positioned radially outward of the second core passage, an atomizing air supply annulus positioned such that it intersects the core passage, and a second gas fuel supply annulus positioned adjacent a radially outer edge of the cover, proximate the forward face.

In an alternate embodiment of the present invention, a cover for a gas turbine is provided comprising a generally cylindrical disk having a forward face, an opposing aft face thereby establishing a thickness therebetween. The cover has a central passageway extending through the cover along a central axis, a first portion of fuel and air circuits positioned within the end cover and arranged in an annular array about the cover, and a second portion of fuel and air circuits positioned within the end cover and arranged in an annular array about the cover. The first portion comprises a first core passage extending along a first circuit centerline, a cooling air supply annulus positioned radially outward of the first core passage, and a first gas fuel supply annulus positioned adjacent the aft face of the cover, where the first cooling air supply annulus and first gas fuel supply annulus provide gas fuel and air to a first plurality of fuel nozzles coupled to the forward face of the cover through angled feed holes. The second portion of fuel and air circuits are also positioned within the end cover and arranged in an annular array about the cover, the second portion comprising a second core passage extending along a second circuit centerline, a cooling air supply annulus positioned radially outward of the second core passage, and a second gas fuel supply annulus positioned adjacent a radially outer edge of the cover and the forward face of the cover, where the cooling air supply annulus provides air to a second plurality of fuel nozzles coupled to the forward face of the cover through angled feed holes.

In yet another alternate embodiment of the present invention, a generally cylindrical disk having a forward face, an opposing aft face thereby establishing a thickness therebetween, a central passageway extending through the thickness of the cover along a central axis, a center fuel nozzle coupled to the disk and in fluid communication with the central passageway, an annular array of fuel and air circuits, the fuel and air circuits split into a first portion and a second portion, a first plurality of fuel nozzles coupled to the fuel and air circuits of the first portion, and a second plurality of fuel nozzles coupled to the fuel and air circuits of the second portion.

In an alternate embodiment of the present invention there is provided a method of fabricating a combustor end cover comprising providing a disk of material, machining a pattern of bolt holes into the disk and machining a central passageway through the disk, a first gas fuel supply annulus in an aft face of the disk, atomizing air and diffusion air annuli in the aft face of the disk, and a second gas fuel supply annulus in a forward face of the disk. A first fuel plenum and second fuel plenum are machined into the forward face of the disk. A plurality of feed holes are drilled at an angle between the first gas fuel supply annulus and the first fuel plenum as well as between the cooling air supply annuli and the air plenums. Once all of the angled feed holes have been drilled, covers are welded over the various annuli on the aft face and forward face of the disk. The cavities for the fuel nozzles are final machined and the nozzle inserts for the fuel nozzles are then welded into place. Finally, the forward and aft faces are final machined and the fuel inlet piping is welded to the aft face of the disk.

In yet another alternate embodiment of the present invention, a distribution system for delivering fuel and air to a fuel nozzle is provided comprising an end cover having an aft face and a forward face with a center passageway extending through a thickness of the cover along a central axis. The first core passage extending along a first circuit centerline, a cooling air supply annulus positioned radially outward of the first core passage, an atomizing air supply annulus positioned such that it intersects the core passage, and a first gas fuel supply annulus located adjacent the aft face of the cover. Each of the fuel and air circuits in the second portion comprises a second core passage extending along a second circuit centerline, a cooling air supply annulus positioned radially outward of the second core passage, an atomizing air supply annulus positioned such that it intersects the core passage, and a second gas fuel supply annulus positioned adjacent a radially outer edge of the cover, proximate the forward face. The cooling air supply annulus, first gas fuel supply and second gas fuel supply are each in fluid communication with a corresponding distribution annulus via a plurality of feed holes. The fuel distribution annulus and air distribution annulus are formed in the cover by removing material of the cover proximate the forward and aft faces such that the fuel and air passageways formed within the cover are formed through all material of the cover.

Additional advantages and features of the present invention will be set forth in part in a description which follows, and in part will become apparent to those skilled in the art upon examination of the following, or may be learned from practice of the invention. The instant invention will now be described with particular reference to the accompanying drawings.

### BRIEF DESCRIPTION OF THE SEVERAL VIEWS OF THE DRAWINGS

The present invention is described in detail below with reference to the attached drawing figures, wherein:

FIG. 1A is a perspective view of a gas turbine combustor cover in accordance with the prior art;

FIG. 1B is a perspective view of a gas turbine combustor cover in accordance with an embodiment of the present invention;

FIG. 2A is a cross section view of a gas turbine combustor cover in accordance with the prior art;

FIG. 2B is a cross section view of a gas turbine combustor cover in accordance with an embodiment of the present invention;

FIG. 3A is a cross section view of a center gas fuel portion of a gas turbine combustor cover in accordance with the prior art;

FIG. 3B is a cross section view of a center gas fuel portion of a gas turbine combustor cover in accordance with an embodiment of the present invention;

FIG. 4A is a cross section view of a diffusion air passage portion of a gas turbine combustor cover in accordance with the prior art;

FIG. 4B is a cross section view of a diffusion air passage portion of a gas turbine combustor cover in accordance with an embodiment of the present invention;

FIG. 5A is an alternate cross section view of a gas turbine combustor cover in accordance with the prior art;

FIG. 5B is an alternate cross section view of a gas turbine combustor cover in accordance with an embodiment of the present invention;

FIG. 6A is a partial cross section view of a fuel passageway of a gas turbine combustor cover in accordance with the prior art;

FIG. 6B is a partial cross section view of a fuel passageway of a gas turbine combustor cover in accordance with an embodiment of the present invention;

FIG. 7A is a partial cross section view of an alternate fuel passageway of a gas turbine combustor cover in accordance with the prior art;

FIG. 7B is a partial cross section view of an alternate fuel passageway of a gas turbine combustor cover in accordance with an embodiment of the present invention;

FIG. 8A is an alternate cross section view of a gas turbine combustor cover in accordance with the prior art;

FIG. 8B is an alternate cross section view of a gas turbine combustor cover in accordance with an embodiment of the present invention;

FIG. 9A is a perspective view of an aft face of the gas turbine combustor cover in accordance with an embodiment of the present invention;

FIG. 9B is a perspective view of a forward face of the gas turbine combustor cover in accordance with an embodiment of the present invention;

FIG. 10A is a perspective view of an aft face of the gas turbine combustor cover during the machining process in accordance with an embodiment of the present invention;

FIG. 10B is a perspective view of a forward face of the gas turbine combustor cover during the machining process in accordance with an embodiment of the present invention;

FIG. 11A is a perspective view of an aft face of the gas turbine combustor cover during a step of the manufacturing process in accordance with an embodiment of the present invention;

FIG. 11B is a perspective view of a forward face of the gas turbine combustor cover during a step of the manufacturing process in accordance with an embodiment of the present invention;

FIGS. 12A and 12B are cross section views taken through the gas turbine combustor cover at various orientations to depict the internal fuel and air circuits of the cover in accordance with an embodiment of the present invention;

FIG. 13A is a perspective view of an aft face of the gas turbine combustor cover depicting the fuel and air feed holes in the cover in accordance with an embodiment of the present invention;

FIG. 13B is a perspective view of a forward face of the gas turbine combustor cover depicting the fuel and air feed holes in the cover in accordance with an embodiment of the present invention;

FIGS. 14A and 14B are cross section views taken through the gas turbine combustor cover at various orientations to show the fuel and air feed holes of the cover in accordance with an embodiment of the present invention;

FIG. 15A is a perspective view of an aft face of the gas turbine combustor cover depicting the enclosed fuel and air annuli in the cover in accordance with an embodiment of the present invention;

FIG. 15B is a perspective view of a forward face of the gas turbine combustor cover depicting the enclosed fuel and air annuli in the cover in accordance with an embodiment of the present invention;

FIGS. 16A and 16B are cross section views taken through the gas turbine combustor cover of FIGS. 15A and 15B, respectively, at various orientations to depict the internal fuel and air circuits of the cover in accordance with an embodiment of the present invention;

FIG. 17A is a perspective view of an aft face of the gas turbine combustor cover depicting the final machined fuel and air cavities in the cover in accordance with an embodiment of the present invention;

FIG. 17B is a perspective view of a forward face of the gas turbine combustor cover depicting the final machined fuel and air cavities in the cover in accordance with an embodiment of the present invention;

FIG. 18A is a perspective view of an aft face of the gas turbine combustor cover depicting nozzle inserts welded in place in the cover in accordance with an embodiment of the present invention;

FIG. 18B is a perspective view of a forward face of the gas turbine combustor cover depicting nozzle inserts welded in place in the cover in accordance with an embodiment of the present invention;

FIG. 19A is a perspective view of an aft face of the gas turbine combustor cover depicting the fuel and air manifold piping welded in place in the cover in accordance with an embodiment of the present invention;

FIG. 19B is a perspective view of a forward face of the gas turbine combustor cover depicting the fuel and air manifold piping welded in place in the cover in accordance with an embodiment of the present invention;

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different components, combinations of components, steps, or combinations of steps similar to the ones described in this document, in conjunction with other present or future technologies.

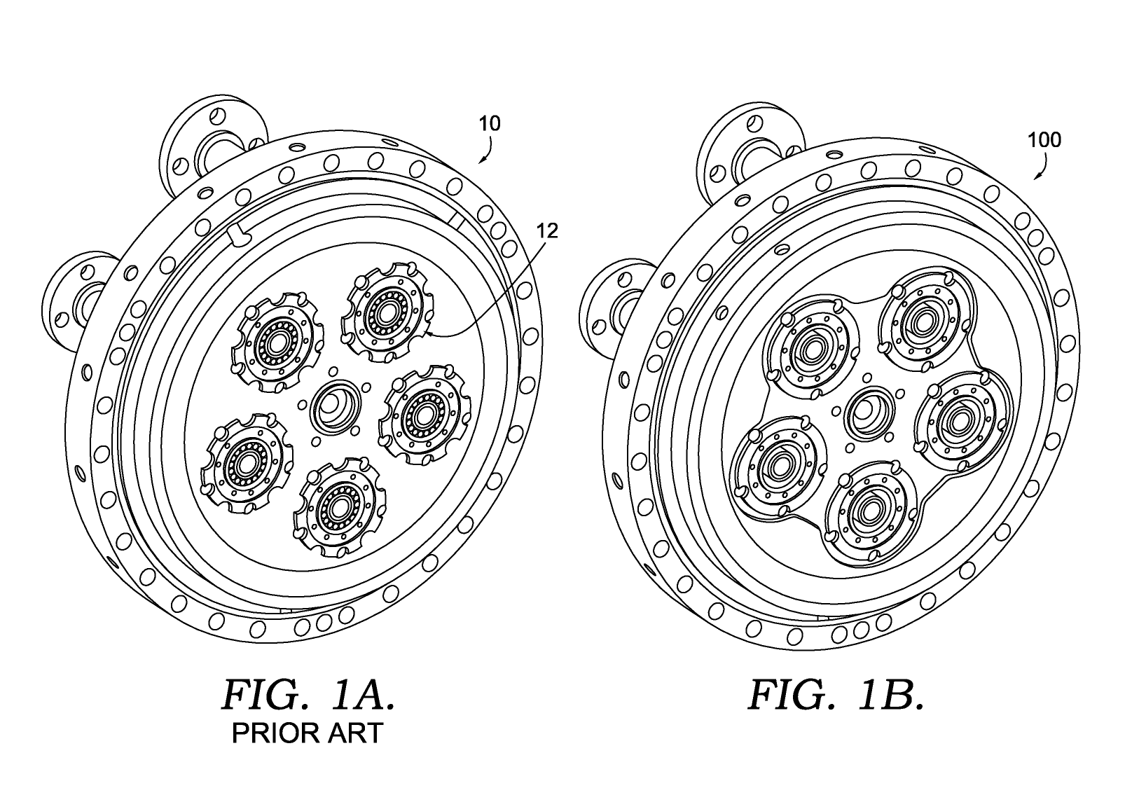

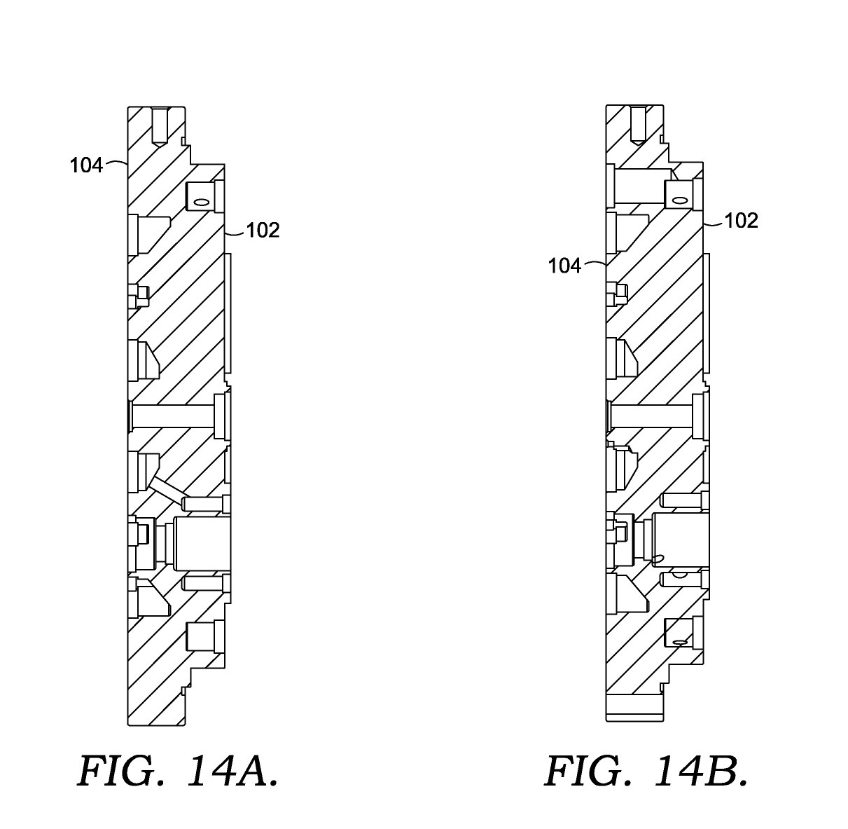

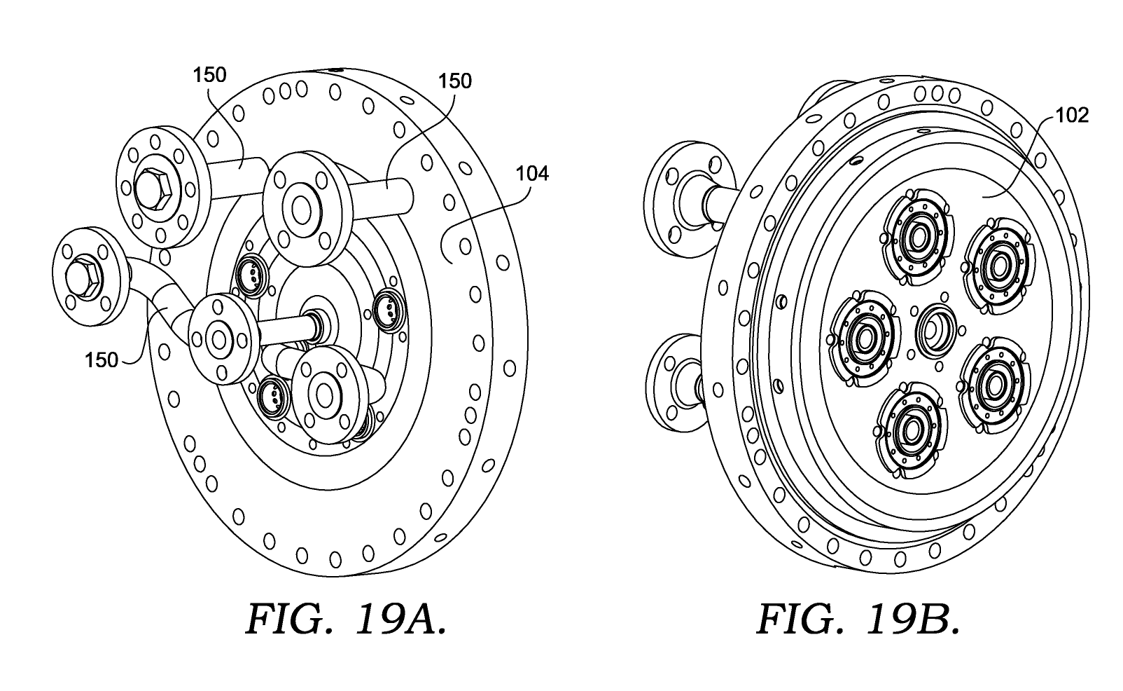

The present invention is described in detail in relation to FIGS. 1B-8B and 9A-19B. The present invention relates to an improved cover design for a gas turbine combustor where the cover geometry eliminates the need for brazing joints within the cover while providing improved channel design for directing fuel and air through the cover. As discussed above, the prior art combustor covers typically required a series of braze joints to be able to facilitate the complex flow of fuels and air within the cover to the various fuel nozzles. Due to various thermal and mechanical conditions, the braze joints have been known to crack and allow fuel to leak into non-fuel passages of the cover, causing additional fuel to be injected into the combustion process and resulting in higher operating emissions and expensive repairs to the cover.

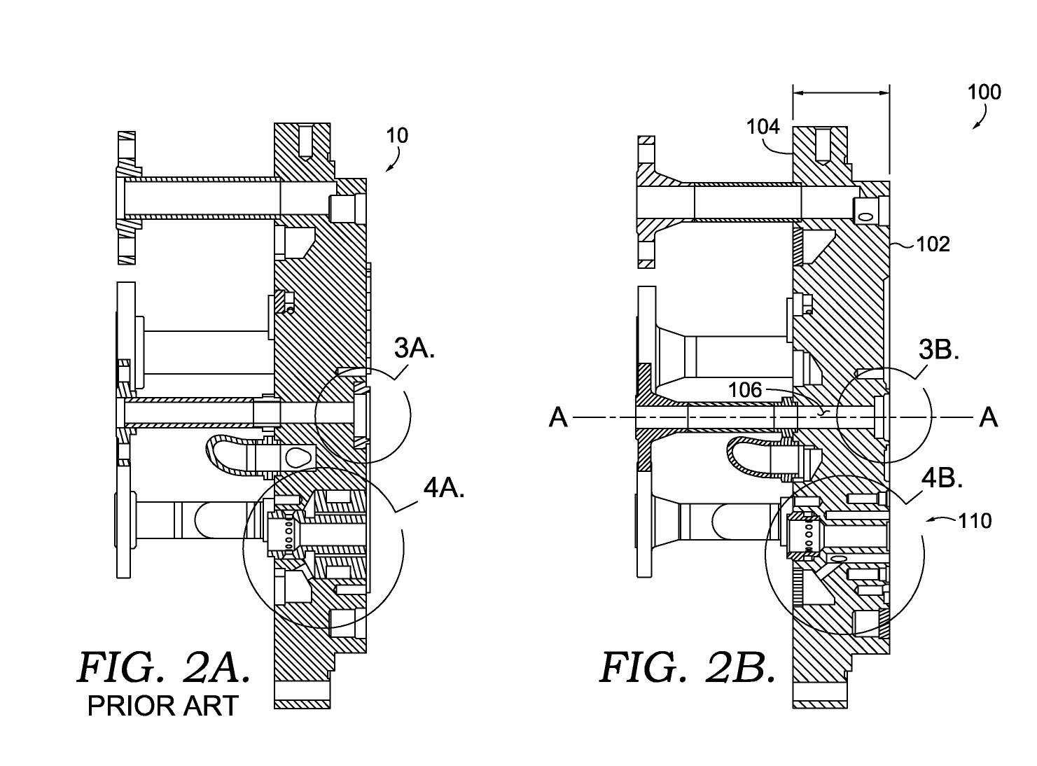

The present invention relates to a cover that is capable of being used in conjunction with a Dry Low NOx (DLN) 2.6 Combustion System or similar hardware, where the combustor has a fuel nozzle along the central axis A-A (see FIG. 2B) and a series of five other fuel nozzles arranged in an annular array about the combustor. The exact quantity and spacing of the fuel nozzles in the annular array may vary depending on the combustor geometry. The cover 100 provides the capability of directing a gaseous fuel and/or a liquid fuel to be passed to the series of fuel nozzles.

Referring initially to FIGS. 1A and 1B, a side-by-side comparison of the cover of the present invention 100 (FIG. 1B) is shown compared to the cover 10 of the prior art (FIG. 1A). From the external view point, there are few noticeable differences. Accordingly, maintaining the external geometry of the prior art cover permits complete interchangeability with respect to the fuel and air feed sources (not shown) and the fuel nozzles (not shown) to be coupled to the cover.

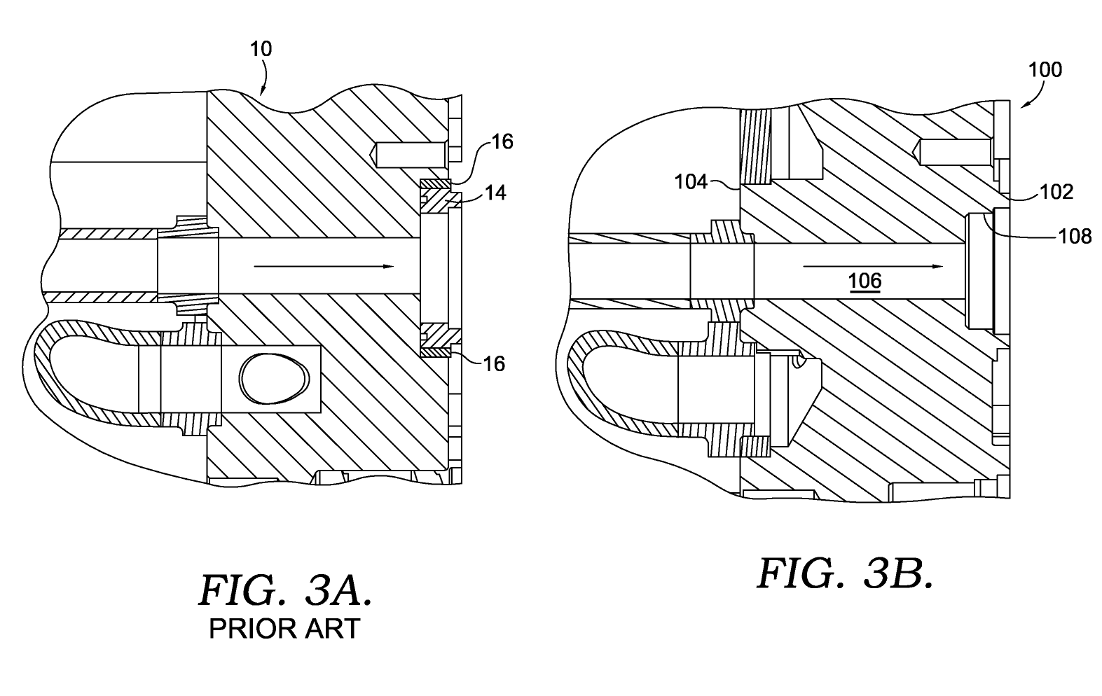

Referring now to FIGS. 2A and 2B, improvements in the cover 100 can be seen when the cover 100 is viewed in cross section. The cover 100, which is generally circular in shape comprises a forward face 102 and an opposing aft face 104, where the aft face 104 is spaced a distance from the forward face 102, thereby establishing a cover thickness T. Referring to FIGS. 2B and 3B, the cover 100 also comprises a central passageway 106 which extends through the cover 100 along a central axis A-A. The central passageway 106 is used to supply a gaseous fuel to a first fuel nozzle (not shown) that is also located along the central axis A-A and secured to the forward face 102 of the cover 100 adjacent machined features 108. The machined features 108 of cover 100 replaces brazing in a machined component 14 into cover 10 via a braze joint 16, as shown in FIG. 3A.

The cover 100 further comprises a plurality of fuel and air circuits, as shown by FIGS. 2B and 4B-7B. As discussed above, one such use of the cover 100 is with a DLN 2.6 combustor, produced by General Electric Company. The DLN 2.6 combustor relies on a sequencing or staging of three main fuel nozzle circuits known more commonly as PM1, PM2, and PM3, coupled to the cover of the combustor. The combustor operates in modes which are made of different fuel circuit combinations—known more commonly as M1 through M6. The PM1 circuit fuels the nozzle positioned along the central axis A-A. The PM2 circuit fuels two of the five outer nozzles, which are arranged in an annular array about the central axis A-A, while the PM3 circuit fuels the remaining three outer nozzles. The three circuits, PM1, PM2, and PM3 work to stage fuel to the six fuel nozzles attached to the cover.

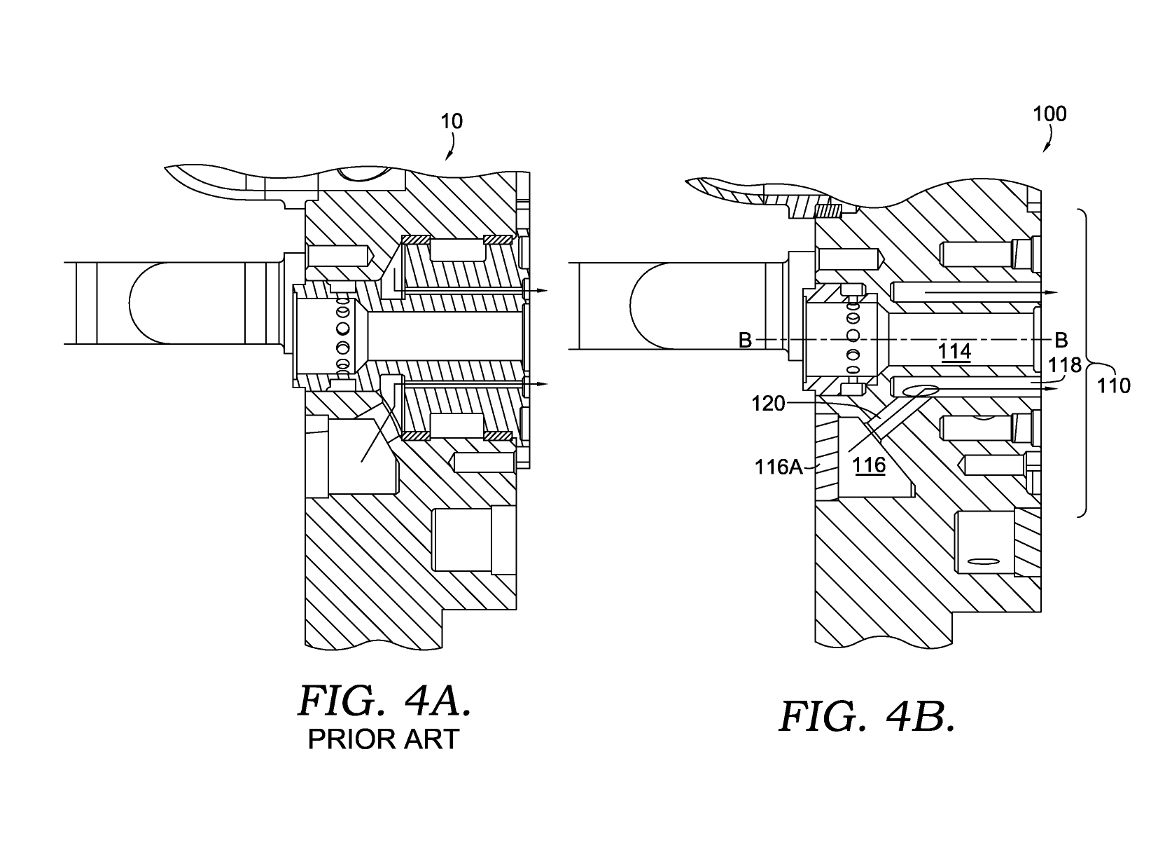

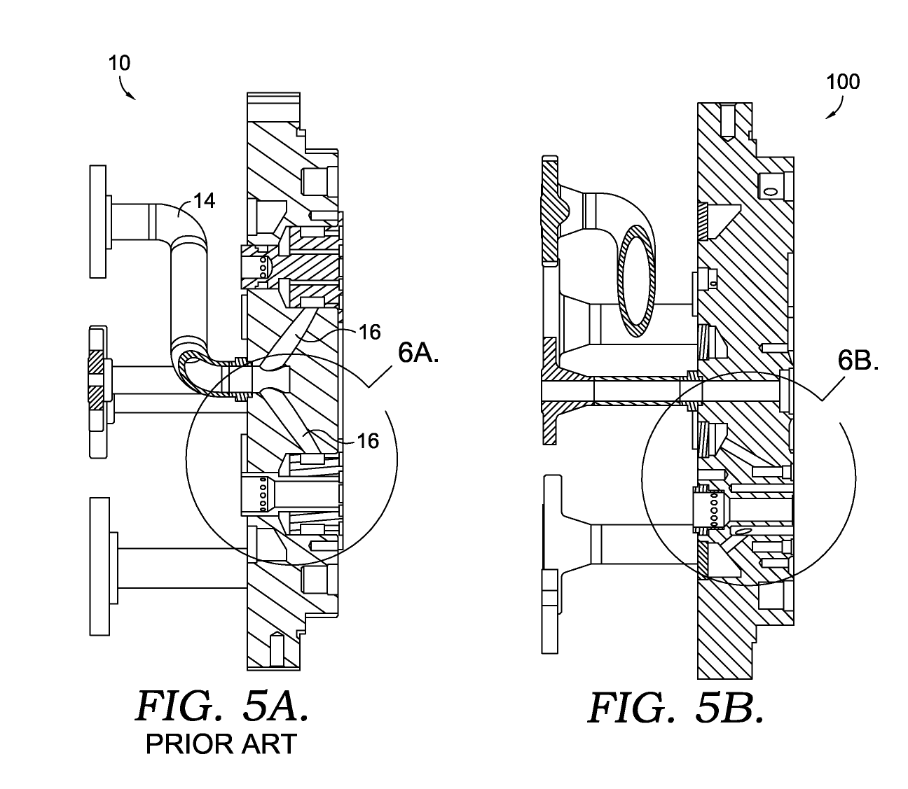

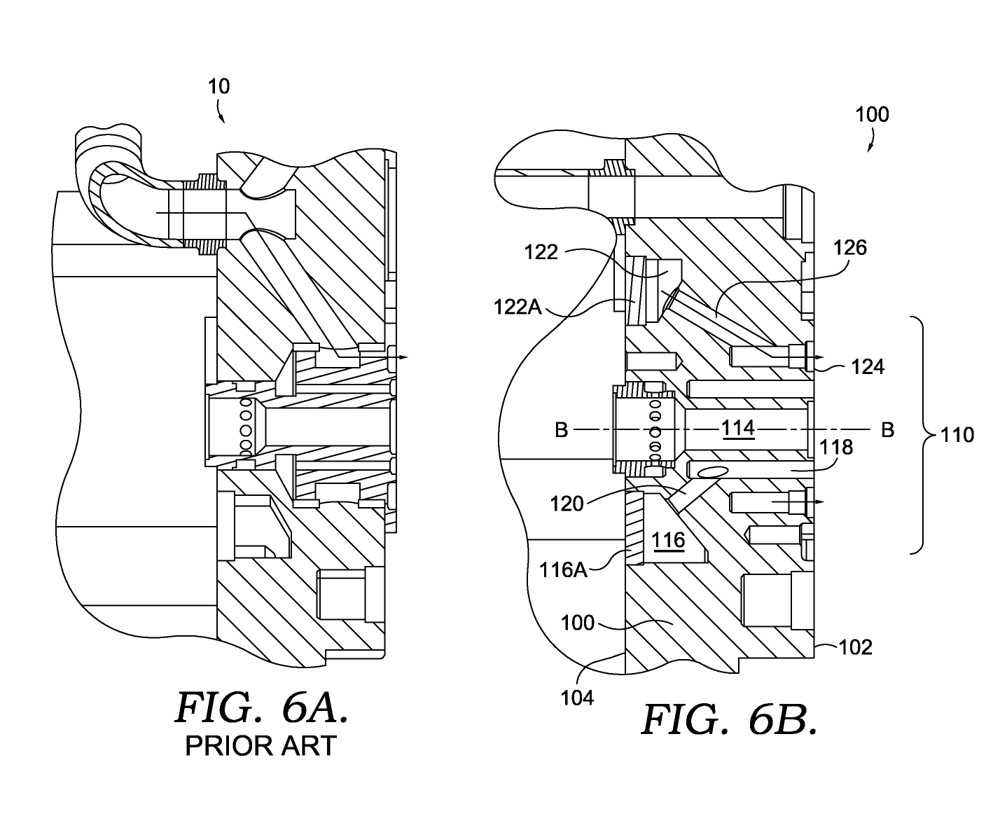

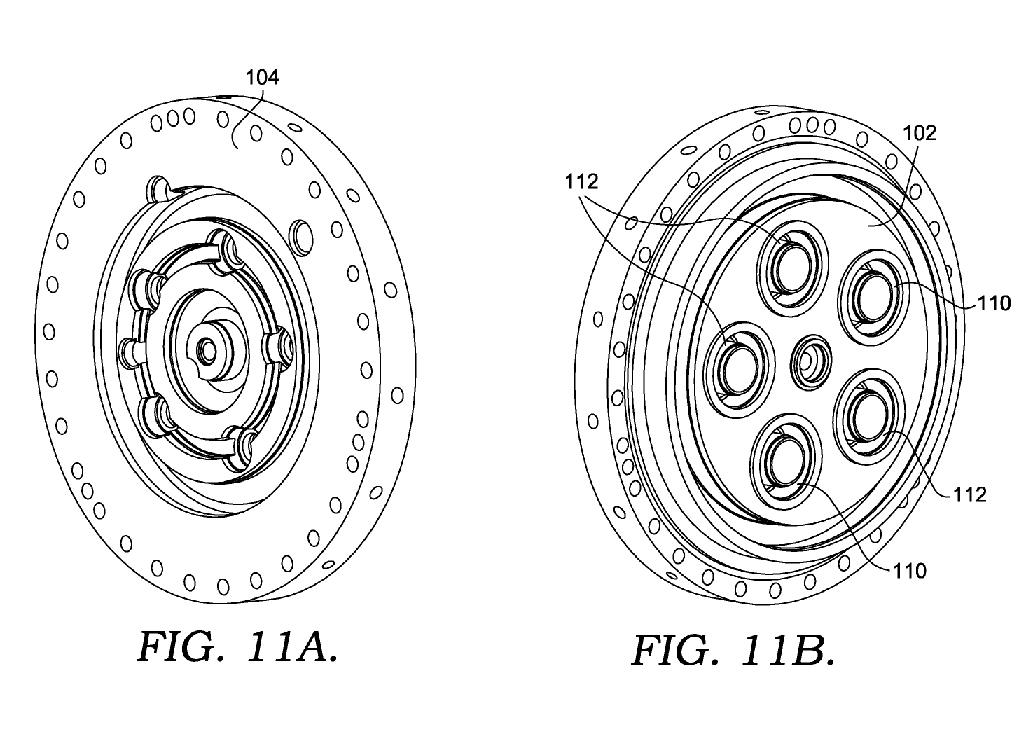

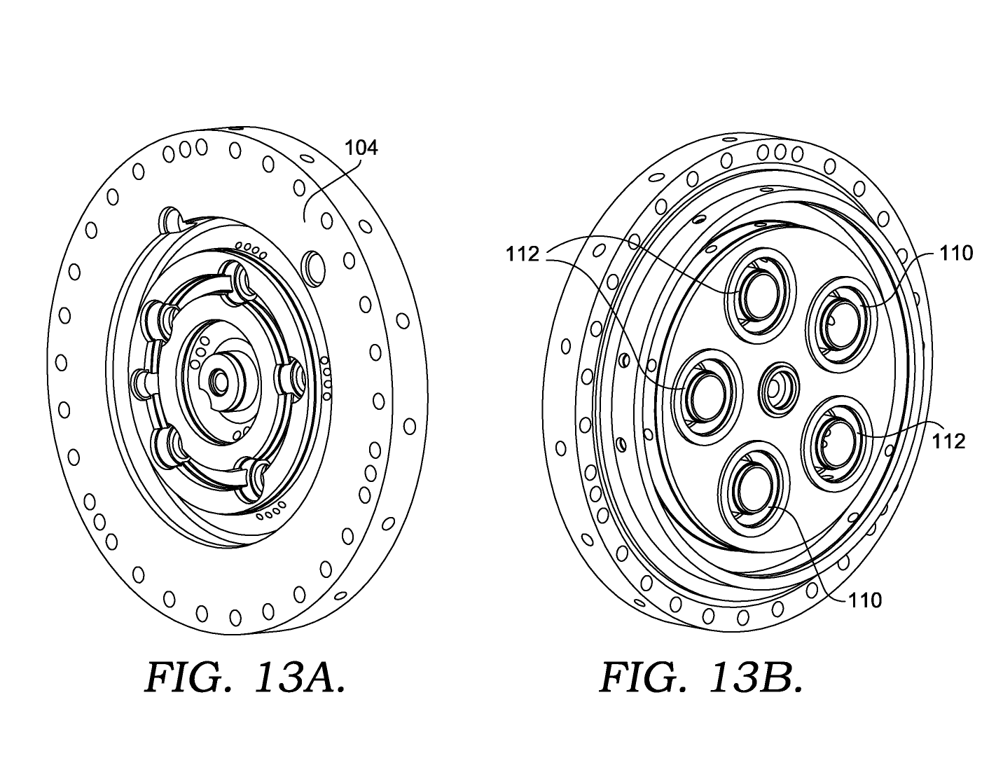

Referring now to FIGS. 11B and 13B, the plurality of fuel and air circuits are divided into a first portion 110 and a second portion 112. For an embodiment of the present invention, the first portion 110 of the fuel and air circuits comprise the PM2 system discussed above, and supplies fuel and air to two fuel nozzles located in the annular array about central axis A-A. More specifically, referring to FIGS. 4B and 6B, the first portion 110, which is located radially outward of the central passageway 106, comprises a first core passage 114 extending along a first circuit centerline B-B. A cooling air supply annulus 116 is positioned about the first core passage 114 and is in fluid communication with an annular cooling air plenum 118 via a plurality of angled cooling air feed holes 120. A cover 116A is placed over annulus 116 in order to seal the annulus 116. Also depicted in FIG. 6B is a first gas fuel supply annulus 122 that is in fluid communication with a first annular gas fuel plenum 124 via a plurality of angled gas feed holes 126. The first gas fuel supply annulus 122 is positioned generally adjacent the aft face 104 of the cover 100. A cover 122A is placed over annulus 122 to seal the annulus 122. The first gas fuel supply annulus 122, which is located radially inward of the air supply annulus 116, directs a supply of gaseous fuel into a plurality of nozzles in the PM2 circuit. Referring back to FIGS. 5A and 6A, prior art cover 10 utilized a feed pipe 18 which then split fuel into two feed passages 20 to the two fuel nozzles of the PM2 circuit. Supplying fuel into an annulus, such as 122 of cover 100 in FIG. 6B provides a more uniform fuel distribution to the gas feed holes 126 compared to the prior art of FIGS. 5A and 6A. In alternate embodiments of the present invention, the first core passage 114 can also provide a region through which other fluids, such as air and/or liquid fuel can flow through additional tubing.

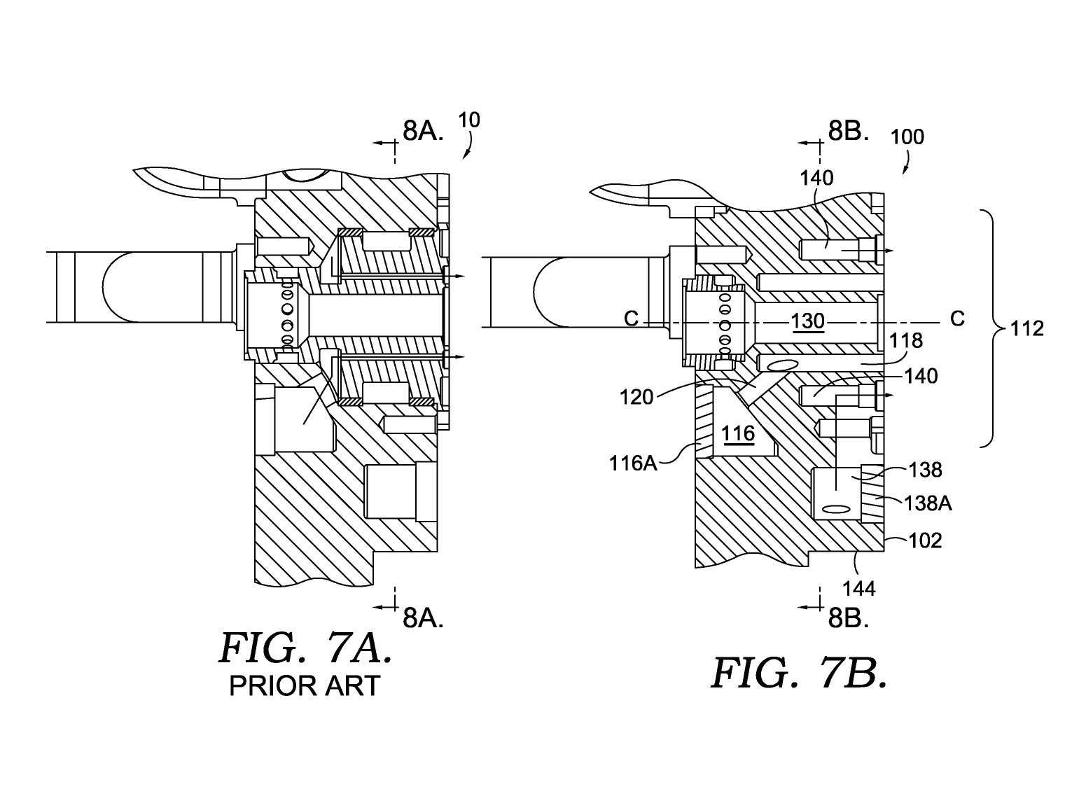

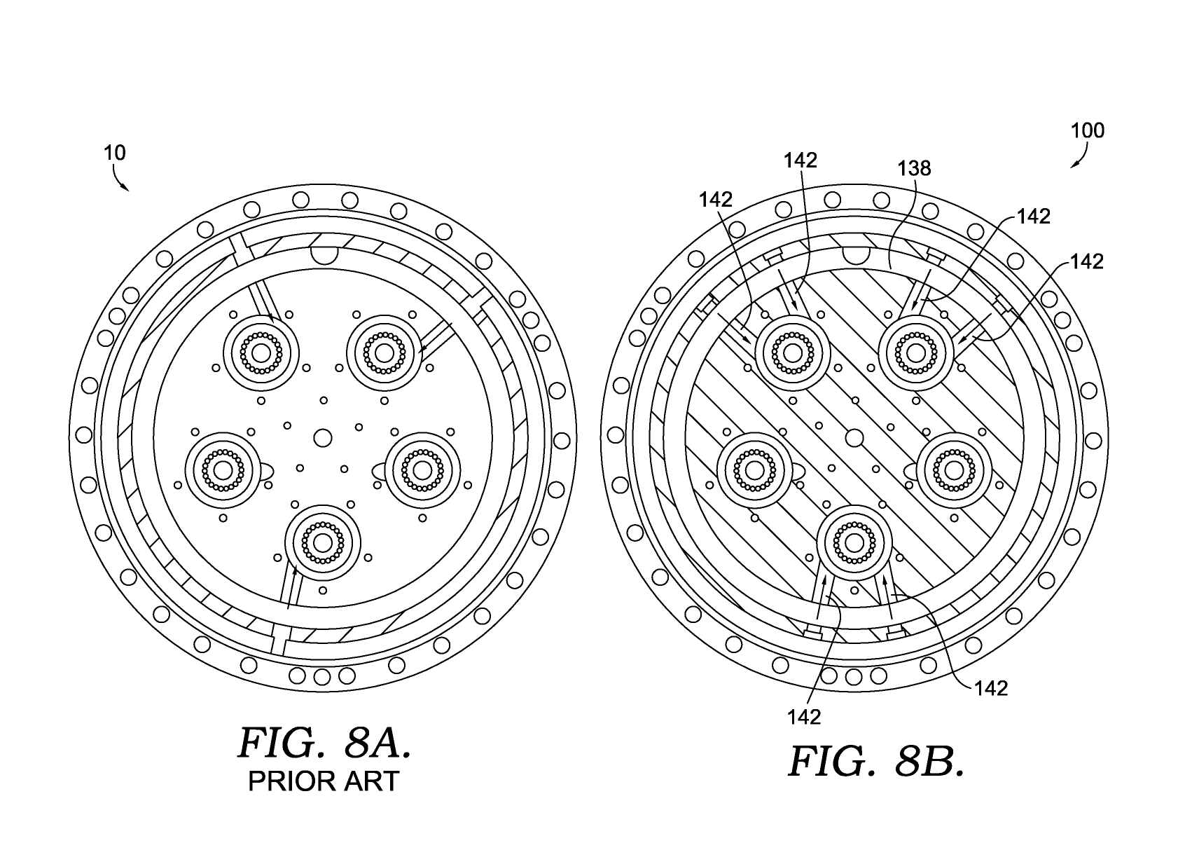

The remaining fuel and air circuits positioned in an annular array about the cover 100 form the second portion 112 and operate in the PM3 circuit, as discussed above. These fuel and air circuits are shown in cross section in FIG. 7B and planar view in FIG. 8B. More specifically, a second portion 112 of the fuel and air circuits each comprise a second core passageway 130 that extends along a second circuit centerline C-C. Similar to the first portion 110, the second portion 112 also comprises an air circuit connected to the air supply annulus 116, which also provides air to the first portion 110, or PM2 circuit. That is, air supply annulus 116 supplies air to cooling air feed holes 120 and to cooling air plenum 118, as shown in FIG. 7B. The air supply annulus 116 of FIG. 7B has a cover 116A positioned over the annulus 116 to seal the annulus 116. Also depicted in FIGS. 7B and 8B is a second gas fuel supply annulus 138 that is in fluid communication with a second annular gas fuel plenum 140 via a plurality of generally radially oriented gas feed holes 142 (see FIG. 8B). The second gas fuel supply annulus 138 is positioned generally adjacent the forward face 102 and a radially outer edge 144 of the cover 100 and has a cover 138A placed over the annulus for sealing the annulus 138. The second gas fuel supply annulus 138 directs a supply of gaseous fuel into a plurality of nozzles in the PM3 circuit, as discussed above. In alternate embodiments, the second core passage 130 can also provide a region through which other fluids, such as air and/or liquid fuel can flow through additional tubing.

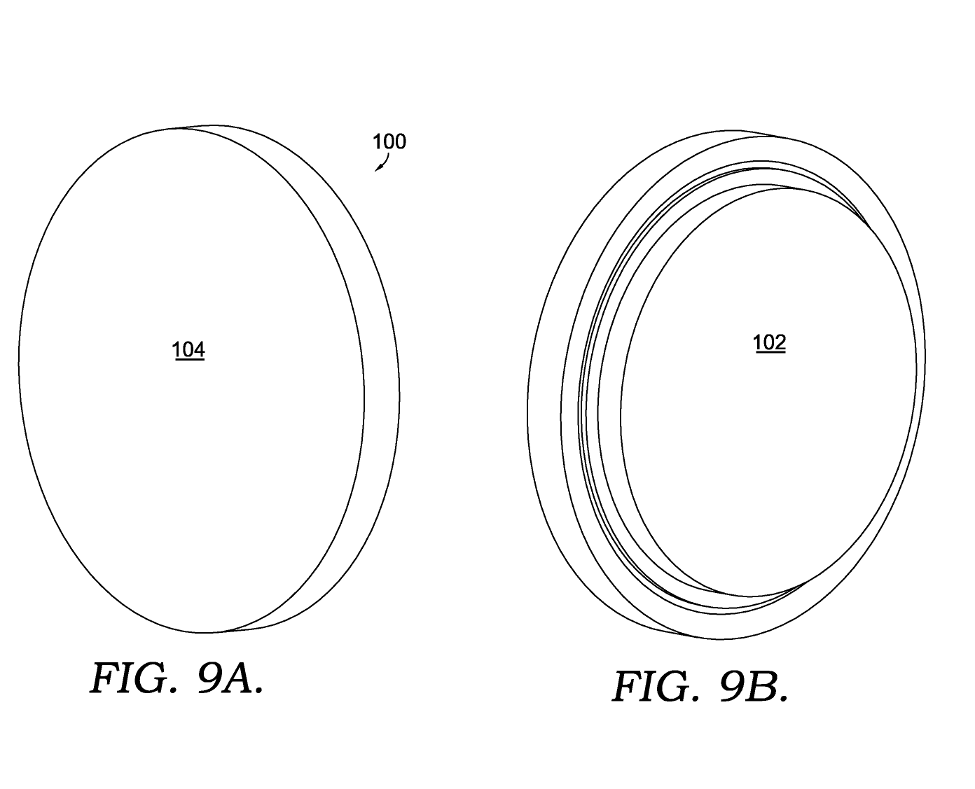

Accordingly, as discussed above, and will be better understood in view of the additional discussion below, the fuel and air passageways in the cover 100 are machined in a way such that the cover 100 is fabricated from a single disk, such as that shown in FIGS. 9A and 9B. The configurations of the fuel and air passageways contained in the cover 100 are located and oriented such that there is no longer a need for the braze joints of the prior art cover 10, which in turn, improves the structural integrity of the cover 100.

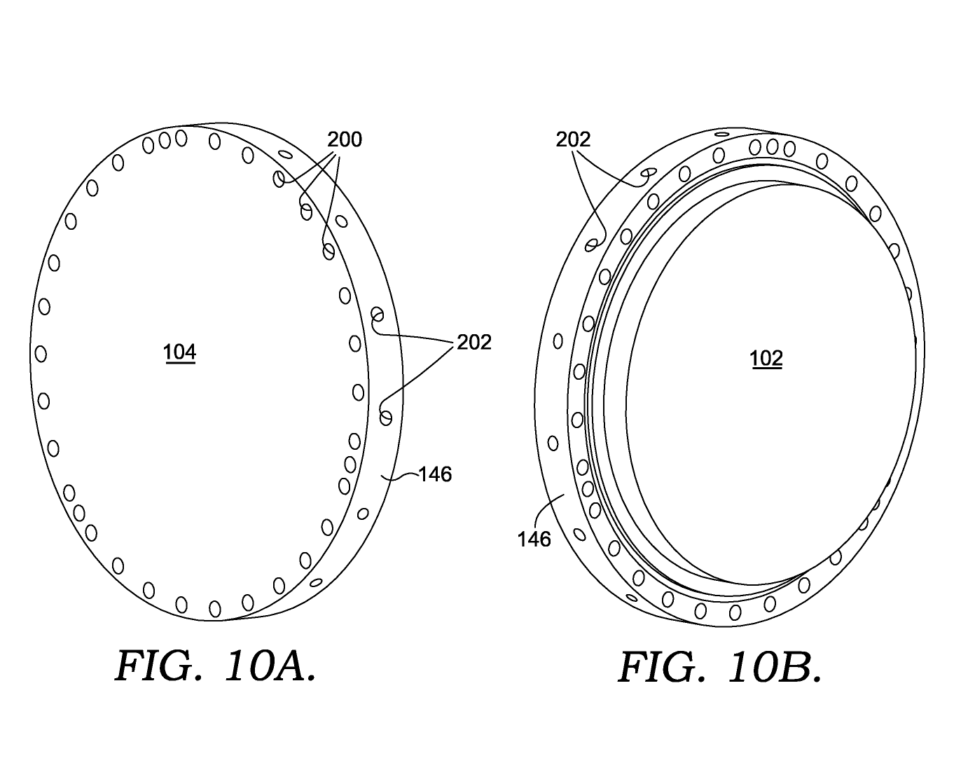

The present invention also pertains to a method of fabricating the combustor cover 100. The general steps and/or sequences for fabricating the cover 100 are depicted in FIGS. 9A-19B. More specifically, referring initially to FIGS. 9A and 9B, a disk of material, preferably a stainless steel, is provided. Next, a plurality of holes 200 are drilled into the disk as shown in FIGS. 10A and 10B. The holes 200 extend from the aft face 104 towards the forward face 102 and are typically through holes (i.e. not threaded) and are used for securing the cover 100 to a combustor case (not shown). Located about a radially outer surface 146 are threaded holes 202. The holes 202 are typically used to aid in lifting and moving the cover 100.

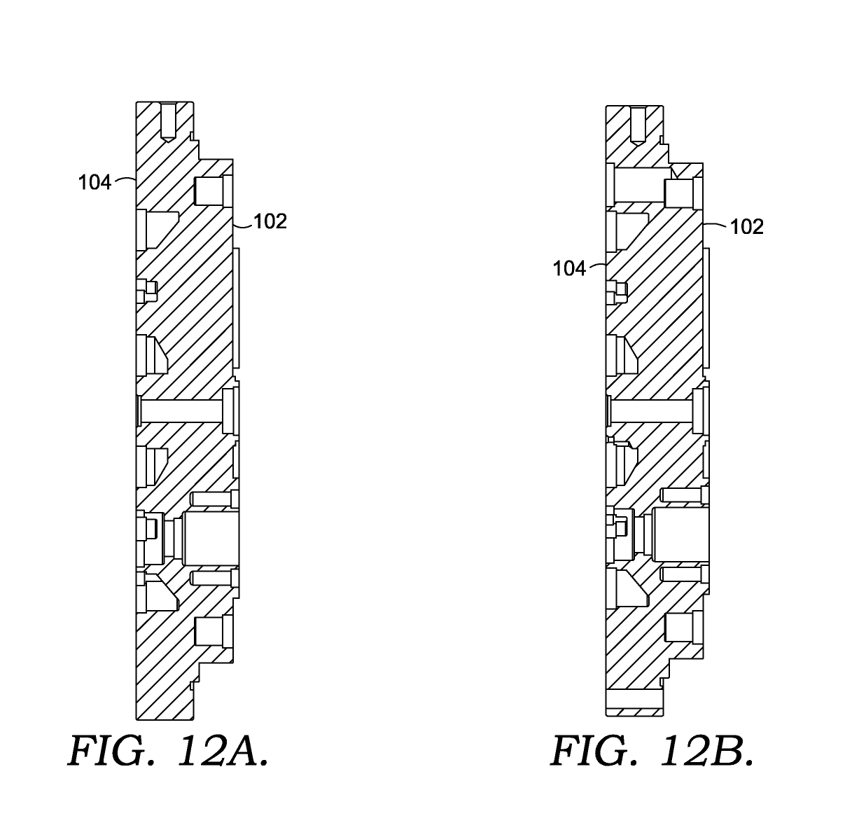

Referring now to FIGS. 11A and 11B, a series of drilling and turning operations are performed to both the forward face 102 and aft face 104 in order to machine the various annular and axially oriented passageways. Specifically, the central passageway 106, the cooling air supply annulus 116, the atomizing air supply annulus 132, the first core passage 114, the second core passageway 130, the first gas fuel supply annulus 122, the second gas fuel supply annulus 138, the cooling air plenum 118, the atomizing air plenum 134, the first annular gas fuel plenum 124, and the second annular gas fuel plenum 140 are each formed through a series of turning (milling) and drilling processes. The various annular passages and axially extending passageways are depicted in FIGS. 12A and 12B.

Once the annular plenums and passageways have been machined into the forward face 102 and aft face 104 of the cover 100, the angled feed holes 120 and 126 are drilled in the cover 100. The angled feed holes drilled during this manufacturing step includes feed holes for the air passage 120 which connects the first cooling air supply annulus 116 to the cooling air plenum 118. Other angled feed holes drilled at this time include the plurality of angled gas feed holes 126 for the PM2 fuel passage. More specifically, angled gas feed holes 126 connect the first gas fuel supply annulus 122 to the first annular gas fuel plenum 124. As it can be seen from FIGS. 6B and 7B, the angled feed holes 120 and 126 are drilled from the aft face 104 of the cover 100 towards the front face 102. By doing so, the angled feed holes are drilled perpendicular to the angled surface within their respective supply annulus (fuel or air), which provides a clean surface for drilling the feed holes. Feed holes 142 for the gas fuel of the PM3 circuit are drilled radially from the second gas fuel supply annulus 138 to the second annular gas fuel plenum 140.

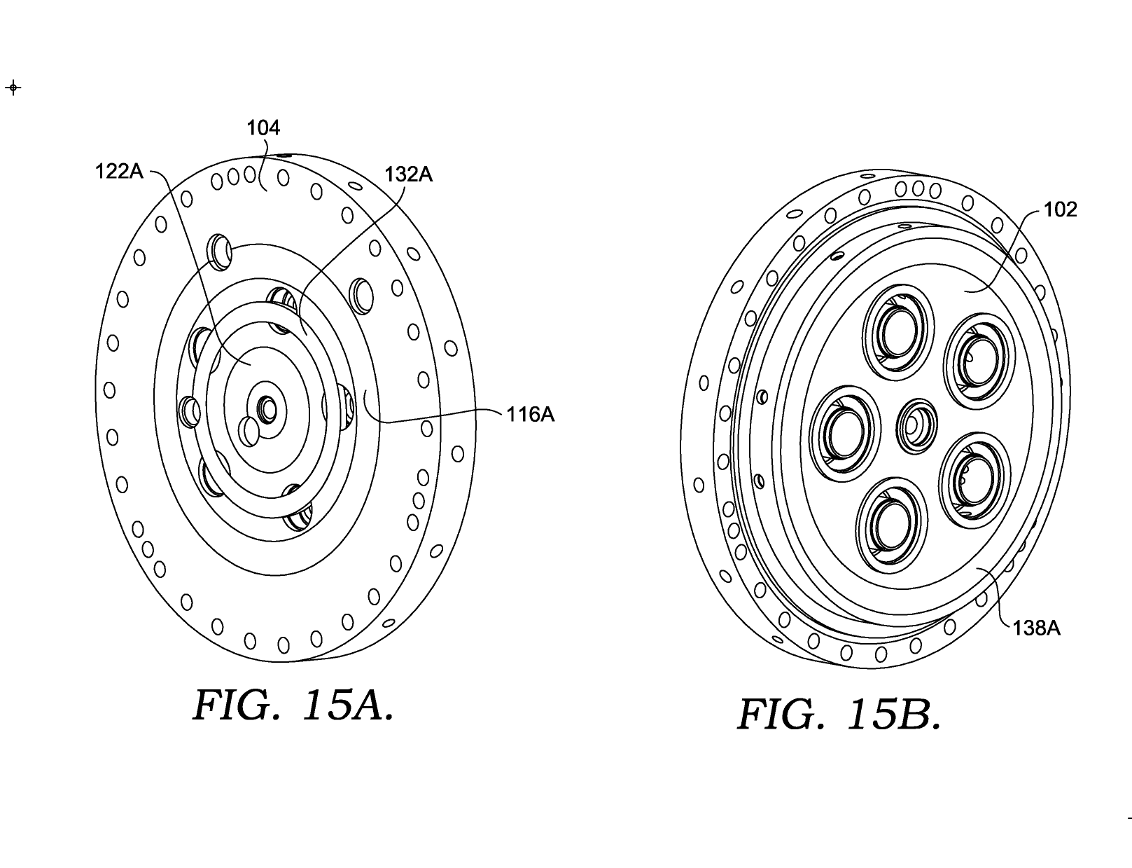

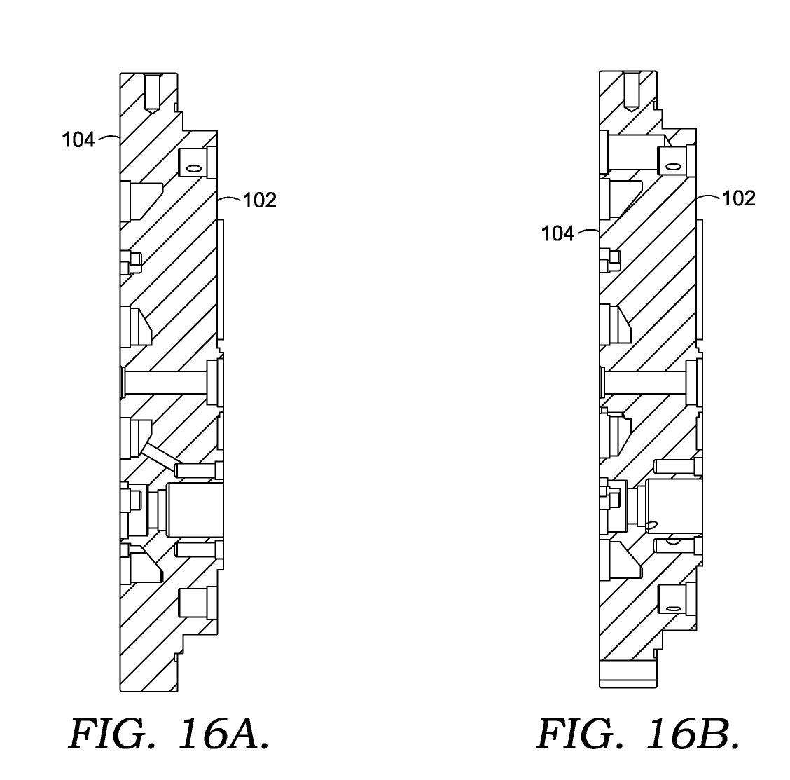

Once the series of annular and angled passageways are machined or drilled in the cover 100, the various annuli are enclosed with a series of covers, as shown in FIGS. 15A, 15B, 16A and 16B. For example, a cover 116A encloses the cooling air supply annulus 116, a cover 122A encloses the first gas fuel supply annulus 122, a cover 132A encloses an atomizing air supply annulus 132 and a cover 138A encloses the second gas fuel supply annulus 138. The covers 116A, 122A, 132A and 138A are preferably fabricated from a material similar to the cover 100 and are welded to the cover 100.

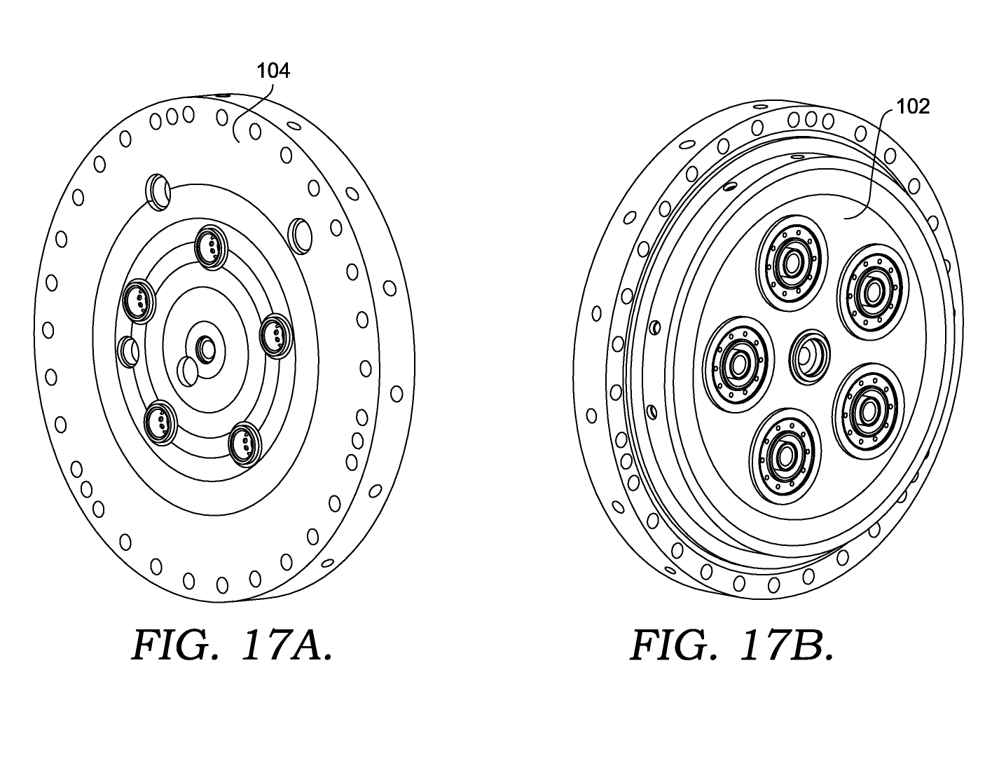

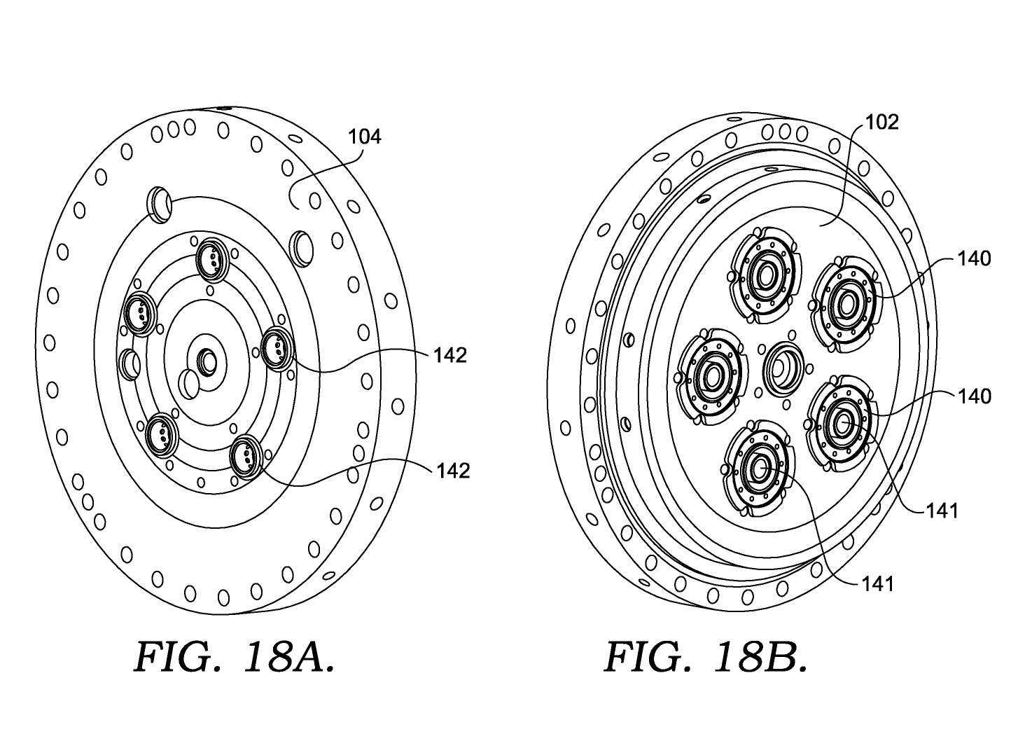

Once the covers 116A, 122A, 132A and 138A have been welded in place, in-process machining to the cover occurs. More specifically, the forward face 102 and aft face 104 of the cover 100 are machined to dimension as well as the regions to which the fuel nozzles will mount and fuel supply pipes will mount, as shown in FIGS. 17A and 17B. More specifically, as shown in FIGS. 18A and 18B, a plurality of inserts 140, 141, and 142 are positioned over the various cavities at the forward face 104 and aft face 102 of the cover 100. The nozzle inserts 140 are welded to the cover 100 in the various annuli in order to encapsulate and meter the fuel flowing to their respective fuel nozzles. Each of the nozzle inserts 140 includes a plurality of openings which entrap removable orifices for metering the fuel flow to the fuel nozzles (not shown).

Once the inserts 140, 141, and 142 are in place, finish-machining of the forward face 102 and aft face 104 is completed. Once finish-machining is complete, the various fuel supply pipes 150 are secured to the forward face 104 of the cover 100. The fuel supply pipes 150 are welded to the cover 100 and are each coupled to respective fuel supply lines. Upon completion of the cover 100, including any welding (pipes 150, nozzle inserts 140, etc.), the cover may be placed in a furnace to stress relieve the cover, according to a predetermined stress relieving cycle.

The present invention has been described in relation to particular embodiments, which are intended in all respects to be illustrative rather than restrictive. Alternative embodiments and required operations will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and within the scope of the claims.

1. A cover for a gas turbine combustor comprising:
a forward face;
an opposing aft face spaced a distance from the forward face, thereby establishing a cover thickness;
a central passageway extending through the cover along a central axis, the central passageway supplying a gaseous fuel to a first fuel nozzle;
a plurality of fuel and air circuits positioned within the end cover and arranged in an annular array about the cover, the fuel and air circuits comprising:
a first portion located radially outward of the central passageway and each having:
a first core passage extending along a first circuit centerline;
a first gas fuel supply annulus positioned adjacent the aft face of the cover;
wherein the first gas fuel supply annulus provides gas fuel to a first plurality of fuel nozzles coupled to the forward face of the cover through angled feed holes;
a second portion located radially outward of the central passageway and each having:
a second core passage extending along a second circuit centerline;
a second gas fuel supply annulus positioned adjacent a radially outer edge of the cover and the forward face of the cover;
wherein the second gas fuel supply annulus provides gas fuel to a second plurality of fuel nozzles coupled to the forward face of the cover through feed holes; and,
a cooling air supply annulus positioned radially outward of the first gas fuel supply annulus and in fluid communication with the first portion and the second portion;
wherein the cooling air supply annulus and the first fuel supply annulus are machined in the opposing aft face of the cover.

2. The cover of claim 1, wherein the angled feed holes of the first portion are oriented at an angle relative to a first circuit centerline of the first core passage.

3. The cover of claim 1 wherein the second gas fuel supply is located radially outward of the cooling air supply annulus.

4. The cover of claim 1, wherein the first portion comprises fuel and air circuits for two fuel nozzles.

5. The cover of claim 4, wherein the second portion comprises fuel and air circuits for three fuel nozzles.

6. The cover of claim 5, wherein the cooling air supply annulus supplies air to five fuel nozzles.

7. The cover of claim 1, wherein the first core passage is formed by one or more inserts fixed within the cover.

8. The cover of claim 7, wherein the second core passage is formed by one or more inserts fixed within the cover.

9. A cover for a gas turbine combustor comprising:
a generally cylindrical disk having a forward face, an opposing aft face thereby establishing a thickness;
a central passageway extending through the cover along a central axis;
a first portion of fuel and air circuits positioned within the end cover and arranged in an annular array about the cover, the first portion comprising:
a first core passage extending along a first circuit centerline;
a cooling air plenum positioned radially outward of the first core passage;
a first gas fuel supply annulus positioned adjacent the aft face of the cover;
wherein the cooling air plenum and first gas fuel supply annulus provide gas fuel and air to a first plurality of fuel nozzles coupled to the forward face of the cover through angled feed holes;
a second portion of fuel and air circuits positioned within the end cover and arranged in an annular array about the cover, the second portion comprising:
a second core passage extending along a second circuit centerline;
a cooling air plenum positioned radially outward of the second core passage;
a second gas fuel supply annulus positioned adjacent a radially outer edge of the cover and the forward face of the cover;
wherein the cooling air plenum and second gas fuel supply annulus provide gas fuel and air to a second plurality of fuel nozzles coupled to the forward face of the cover through feed holes.

10. The cover of claim 9, wherein the central passageway supplies a gaseous fuel to a first fuel nozzle positioned along the central axis, the first fuel nozzle secured to the forward face of the cover.

11. The cover of claim 9, wherein the first gas fuel supply is located radially inward of a cooling air supply annulus.

12. The cover of claim 11, wherein the second gas fuel supply is located radially outward of a cooling air supply annulus.

13. The cover of claim 9, wherein the first portion comprises two fuel and air circuits.

14. The cover of claim 13, wherein the second portion comprises three fuel and air circuits.

15. The cover of claim 9, wherein the first core passage is formed by one or more inserts fixed within the cover.

16. The cover of claim 15, wherein the second core passage is formed by one or more inserts fixed within the cover.

17. A cover assembly for a gas turbine combustor comprising:
a generally cylindrical disk having a forward face, an opposing aft face, and having a thickness therebetween;
a central passageway extending through the thickness of the cover along a central axis; and,
an annular array of fuel and air circuits, the fuel and air circuits split into a first portion and a second portion, the first portion having a fuel annulus located adjacent the opposing aft face of the cover and the second portion having a fuel annulus adjacent the opposing forward face of the cover, both the first and second portion share a cooling air annulus located adjacent the opposing aft face of the cover.

18. The cover assembly of claim 17, wherein the first portion comprises fuel and air circuits for two fuel nozzles located in an annular array about the central passageway.

19. The cover assembly of claim 18, wherein the second portion comprises fuel and air circuits for three fuel nozzles located in the annular array about the central passageway.

20. The cover assembly of claim 17, wherein the fuel annulus of the first portion is located radially inward of the cooling air annulus.
